(19) United States
(12) Patent Application Publication
(10) Pub. No.: US 2007/0189505 A1
(43) Pub. Date: Aug. 16, 2007

(54) Detecting reflections in a communication channel

(75) Inventors: Roman A. Dyba, Austin, TX (US); Perry P. He, Austin, TX (US); Lucio F.C. Pessoa, Cedar Park, TX (US)

Correspondence Address: LAW OFFICE OF CHARLES W. BETHARDS, LLP, P.O. BOX 1622, COLLEYVILLE, TX, 76034, US

(73) Assignee: Freescale Semiconductor, Inc.

(21) Appl. No.: 11/343,781

(22) Filed: Jan. 31, 2006

(51) Int. Cl. H04M 9/08

(52) U.S. Cl. 379/406.01

(57) ABSTRACT

A system (301) and corresponding method (1200) are arranged for detecting reflections in a communication channel. The system comprises first and second multi-rate filters (311, 313) having bandpass characteristics and configured to provide first and second filtered signals, a sub rate adaptive filter (315) configured to process the filtered signals to provide filter coefficients; and a coefficient analyzer (317) configured to analyze the filter coefficients and provide a time delay corresponding to each of one or more reflections.

### FIELD OF THE INVENTION

This invention relates in general to echo cancellers and more specifically to techniques and apparatus for detecting reflections for echo cancellation in communication channels.

### BACKGROUND OF THE INVENTION

Echo cancellers are known and widely used for reducing audible echoes that may arise in communication channels, e.g. telephony channels. Echoes or reflections typically result from impedance mismatches, e.g., from one or more hybrids, somewhere in the channel and result, for example, in a portion of a received signal being added to a transmit signal or vice versa. When these reflections or echoes are at a low level, users of the channel can be annoyed while higher levels may be untenable for the users.

Echo cancellers are used to identify energy that is due to reflections and once identified to mitigate or reduce this energy and any undesired impact on users of the channel. Echo cancellers are complex and notorious for consuming or requiring large amounts of signal processing resources, e.g., memory and processor capacity in order to provide a robust echo canceller, i.e., an echo canceller that is effective over a broad range of variable and changing conditions. Practitioners have attempted to reduce the signal processing capacity or processing cost that is required to perform echo cancellation.

For example, if an echo or reflection can be detected and located in time, processing costs for reducing or mitigating the impact of the echo can be reduced. As a result many echo cancellers now have echo or reflection detectors that attempt to identify and temporally locate reflections. Unfortunately, echo or reflection detectors can still use significant processing capacity.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in a simplified and representative form, a high level diagram of a communication system suitable for using a method or system for detecting reflections in accordance with one or more embodiments;

FIG. 2 in a representative form, shows a diagram of reflections that may be encountered in a communication channel;

FIG. 3 depicts a representative diagram of an echo canceller system including a system for detecting reflections in a communication channel in accordance with one or more embodiments;

FIG. 4 depicts a representative and more detailed high level diagram of a system for detecting reflections in accordance with one or more embodiments;

FIG. 5 depicts a diagram of a response for each of three Goertzel filters suitable for use in one or more embodiments of the FIG. 4 system for detecting reflections in accordance with one or more embodiments;

FIG. 6 and FIG. 7, respectively, illustrate diagrams of a response for each of three resonant filters and a composite response suitable for use in one or more embodiments of the FIG. 4 system for detecting reflections in accordance with one or more embodiments;

FIG. 8 illustrates a diagram of another composite response for a further embodiment of three resonant filters suitable for use in one or more embodiments of the FIG. 4 system for detecting reflections in accordance with one or more embodiments;

FIG. 9 depicts another embodiment of a multi-rate filtering system suitable for use in the system for detecting reflections of FIG. 3 in accordance with one or more embodiments;

FIG. 10 illustrates a diagram of a composite response for the multi-rate filtering system of FIG. 9 in accordance with one or more embodiments; and

FIG. 11 depicts various amplitude characteristic distribution diagrams in accordance with various standardized echo models; and

FIG. 12 shows a flow chart illustrating representative embodiments of one or more methods of detecting reflections in a communication channel.

### DETAILED DESCRIPTION

In overview, the present disclosure concerns echo cancellers for communication channels, e.g., telephony channels or the like, and more specifically techniques and apparatus for detecting reflections or echoes in such channels. The techniques and apparatus are arranged and constructed for improving or reducing processing costs in terms of memory and processing capacity or calculations that is required for detecting the reflections. More particularly various inventive concepts and principles embodied in methods and apparatus, e.g., methods of and corresponding reflection detection systems, that advantageously use multi-rate filters will be discussed and disclosed.

The methods and apparatus of particular interest may vary widely but include approaches using multi-rate filters that purposely trade off less selectivity and corresponding increases in aliasing energy for reduced processing costs or requirements. In systems, equipment and devices that employ echo cancellers and corresponding echo or reflection detectors, the inventive apparatus and methods can be particularly advantageously utilized, provided they are practiced in accordance with the inventive concepts and principles as taught herein.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in integrated circuits (ICs) including possibly application specific ICs or ICs with integrated processing controlled by embedded software or firmware. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the various embodiments.

Referring to FIG. 1, a simplified and representative high level diagram of a communication system suitable for using a method or system for detecting reflections in accordance with one or more embodiments will be briefly discussed and described. In FIG. 1 the representative communication system is a telephone system that further shows a 2 wire side with a telephone 101. The telephone is coupled to a 4 wire segment 103 with a hybrid 104 or hybrid circuit. The hybrid 104, as known, converts a 2 wire loop with signals traveling in both directions, i.e., to and from the telephone, to a 4 wire circuit or loop with transmit signals from the telephone traveling in one direction on one path and receive signal traveling in the opposite direction on another path all as shown. The 4 wire segment 103 is coupled via a 2 wire trunk to a 4 wire network side 105. The two wire trunk is terminated at the network side or near end network side by a hybrid 106 and at the 4 wire segment 103 by a hybrid 108. Typically the 4 wire segment will not be present in many systems and the 4 wire network side 105 may be referred to as a local or central office and is typically the location where local loops and corresponding signals are switched to trunked connections or circuits. The hybrid 106 routes signals or traffic sent from the telephone via the 2 wire trunk to the upper path, designated Sin (signal from near end) 107 and routes signals or traffic destined for or to be received by the telephone, designated Rout (signal to near end) 109 to the 2 wire trunk and thus telephone. Note that in this disclosure the path or terminal and corresponding signals carried thereby or thereon will be interchangeably referred to by the reference number associated with the path or terminal. Imperfections in the hybrids (finite isolation between the various paths) typically result in echoes or reflections 111, 113, 115 as shown. Another significant source of echoes or reflections may be the acoustical path from the earpiece to the mouthpiece of the telephone.

Each of these can contribute to energy corresponding to Rout 107 that is reflected in Sin and possibly delayed versions of Sin being improperly imposed on Sin 107 and this energy is typically referred to as reflections or echoes. Sin is coupled to an echo canceller 117 which removes or reduces any echoes or reflections and provides Sout 119 for transmission to the far end or destination. Rin 121 is coupled to the echo canceller 117 and is typically used in the echo cancellation processes by the echo canceller and is coupled from the echo canceller 117 as Rout 109.

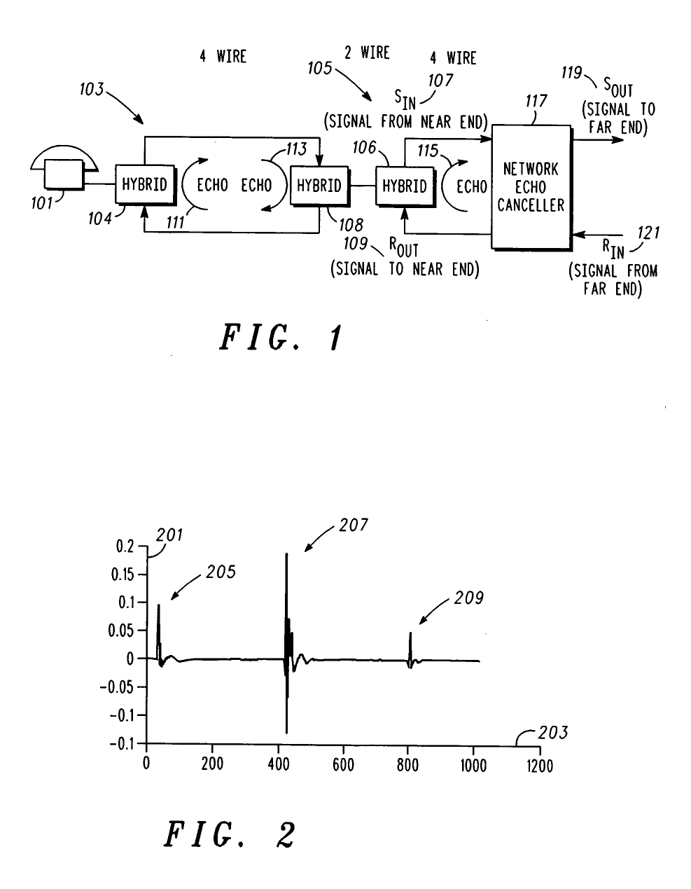

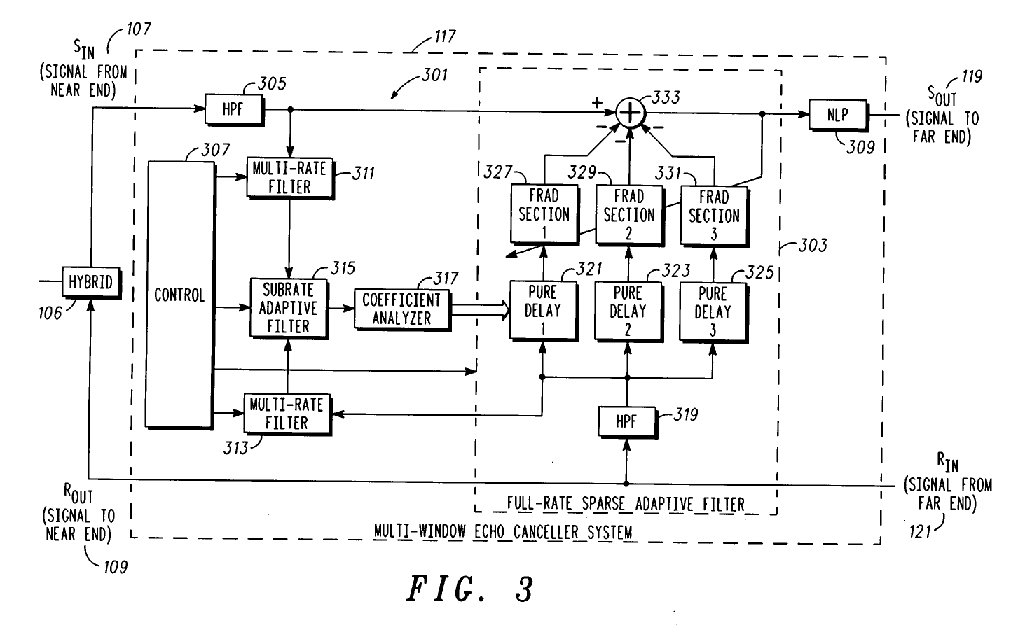

Referring to FIG. 2, a representative diagram of reflections that may be encountered in a communication channel, e.g., the channel of FIG. 1, will be briefly discussed and described. FIG. 2 shows a graph with sample number on a horizontal axis 203, where the sample rate is 8 KS/s (thousand samples per second), i.e., 1000 samples is equivalent to 125 ms (milli-seconds), and a relative magnitude on a vertical axis 201. The graph of FIG. 2 may be observed when an impulse is applied to the channel at Rout 109. An echo or reflection 205 is observed near 40 samples (5 ms) and this reflection is likely due to hybrid 106 and is the signal that would be observed at Sin 107 in response to the impulse at Rout 109. A second reflection 207 is observed near 440 samples (55 ms) and this reflection is likely due to the channel to the left of the hybrid 106, including an acoustical path from the earpiece to the mouthpiece of the telephone 101. A third reflection 209 is observed near sample 810 (101 ms) which may be due to a further response, such as ringing or secondary reflection in the 4 wire segment 103, of the channel to the left of the hybrid 106 or the acoustical path from the earpiece to the mouthpiece of the telephone 101. This pattern of echoes or reflections is often referred to as a sparse echo pattern, in that the various reflections tend to be isolated in time from each other. The echo canceller 117 operates to reduce and otherwise mitigate any impact from these reflections. Once the location of the reflections is known, the processing capacity or cost of the echo canceller can be reduced, since cancellation can be focused on the regions where the echoes are located. Determining these regions is the task that is performed by an echo or reflection detector or corresponding methods thereof.

Referring to FIG. 3, a representative diagram of an echo canceller system including a system for detecting reflections in a communication channel, such as a channel, e.g., telephone channel, that is sending near end signals, in accordance with one or more embodiments will be discussed and described. FIG. 3 shows hybrid 106, Sin 107 output from hybrid 106, Rout 109 input to hybrid 106, a more detailed block diagram of echo canceller 117 inter coupled as shown, Sout 119 from the echo canceller, and Rin 121 coupled to the echo canceller. Sin 107 (including a signal being transmitted together with any reflections) is coupled to a reflection detector or system for detecting reflections 301 in a communication channel and to a full rate adaptive filter 303 via an optional high pass filter 305. By virtue of the high pass filter the output of this filter is often referred to as filtered Sin, however in this disclosure Sin will be used where it is understood that this may be a high pass filtered version of Sin. Note that Rin 121 is also coupled to the full rate adaptive filter 303 as well as the system for detecting reflections 301. The output from the full rate adaptive filter 303 is coupled to a non linear processor (NLP) 309 with Sout 119 being provided by the NLP 309. The high pass filter 305 is known and operates to remove very low frequency elements, e.g., any DC component, etc. The NLP 309 is also known and operates, for example, to remove any vestiges of echoes or echo cancellation artifacts and may add a background level of noise, i.e., comfort noise.

For the sake of simplicity and in. order to avoid confusing the present inventive concepts and principles, as will be evident to those of ordinary skill various functions ordinarily associated with echo cancellers and the like, e.g., level detection and normalization functions and so forth, are not specifically shown. Additionally analog to digital and digital to analog converters are not specifically shown. That notwithstanding, it is understood that most if not all of the functionality shown in FIG. 3 will typically be implemented in the sampled data domain with appropriate sampling rates for signals of interest. For example, in a telephony channel, the sample rate is ordinarily 8 KS/s where each sample is 8 bits in length.

Generally the echo canceller 117 or echo canceller system detects reflections via the system for detecting reflections 301 and once the location (temporal) of one or more of these reflections has been determined, the full rate adaptive filter removes or mitigates the reflected energy within Sin near and around the location where the reflection has been detected. The controller 307 can be a general purpose micro controller or more specialized controller that provides basic control functions (enabling, disabling, initial conditions setting, sequencing, etc.) for the echo canceller, e.g., for the reflection detector 301, full rate adaptive filter 303, and NLP 309. These control functions are generally known or will be evident to those of ordinary skill and will not be further discussed other than as may be appropriate for the various embodiments. Much of the functionality of the echo canceller can advantageously be implemented in a digital signal processor (DSP) executing appropriate software and the controller 307 may also be implemented in the DSP.

The system for detecting reflections (alternatively referred to as an echo or reflection detector) 301 includes a multi-rate filtering system 311 or multi-rate filter and another multi-rate filtering system 313 or multi-rate filter. The multi-rate filters or filtering systems in one or more embodiments have a bandpass characteristic, i.e., include one or more bandpass filters. The multi-rate filtering systems 311, 313 each have an associated processing cost or require a certain amount of processing capacity in order to appropriately function. Typically these multi-rate filters will be similar with similar processing costs or capacity requirements although they need not be. The multi-rate filtering systems 311 is configured to filter and decimate a first signal at a first sample rate, e.g., Sin 107 (as high pass filtered) at 8 KS/s, and provide a corresponding first filtered signal at a first reduced sample rate, e.g., 1 KS/s. The multi-rate filtering systems 313 is configured to filter and decimate a second signal at a second sample rate, e.g., Rout 109 (as filtered by optional high pass filter 319) at 8 KS/s, and provide a corresponding second filtered signal at a second reduced sample rate, e.g., 1 KS/s. Typically the multi rate filter systems 311, 313 operate at the same sample rates and provide corresponding signals with the same reduced sample rate, although that need not be the situation.

In any event, at least one of the processing costs or processing capacities associated with one of the multi-rate filtering systems 311, 313 is reduced by increasing or allowing an increase in aliasing due to the multi-rate filtering. Typically as is known when a signal is sampled, copies of the signal will be created that are centered at multiples of or harmonics of the sampling frequency or rate. These copies of the signal result in aliasing energy that normally must be removed in order to faithfully recover the original signal. For a signal that is sampled at the Nyquist rate, i.e., twice the highest frequency in the signal, an ideal filter with a cutoff frequency equal to the highest frequency in the signal and a box like shape is required in order to remove the aliasing energy. Ideal filters are not possible to implement and practitioners realize that processing costs or capacity increases dramatically as an actual filter approaches the ideal box like response. In practice sample rates are increased thereby moving the desired and aliased versions of a signal further apart in the frequency domain, such that practical filters can be implemented that reduce aliasing energy to a level that is not significant in a particular application. For example, in some applications, reducing aliasing energy by 20 dB is sufficient while others may require 40 dB, however even at these levels the processing costs or processing capacity in terms of memory and processor cycles or calculations that needs to be devoted to filters is non trivial. It has been discovered that reducing aliasing energy by as little as 6 dB is often sufficient to realize a reflection detector that is reliable. Thus a multi-rate filter or filtering system for a reflection detector can be realized where processing costs are dramatically reduced by allowing aliasing to increase.

Outputs from the multi-rate filters 311, 313 are coupled to a sub rate adaptive filter 315 which is configured to process the filtered signals from each of the multi-rate filters to provide filter coefficients. Filter coefficients as determined by the sub rate adaptive filter 315 are coupled to a coefficient analyzer or analysis function 317 and this analyzer is configured to analyze and otherwise process the filter coefficients to provide a time delay corresponding to each of one or more reflections. Generally the sub rate adaptive filter 315 is known and operates to adapt to the filtered signals at the reduced sample rate as provided by the multi-rate filter systems 311, 313. The adapting process results in determining filter coefficients, where the filter coefficients correspond to various delays associated with the filtered signals. Similarly, the coefficient analyzer 317 is known and generally operates to determine whether any coefficient or set of coefficient(s) exceeds a threshold and if so determines a corresponding delay. These delays are passed to the full rate adaptive filter 303.

The full rate adaptive filter 303 is generally known and may optionally include a high pass filter 319 (similar to filter 305) to remove low frequency energy, e.g., DC component of Rin 121. Then a pure delay is added to Rin 121 by delay function 1 321, delay function 2 323, delay function 3 325, etc., where these different delays are provided by the coefficient analyzer 317 with each delay corresponding to a temporal location for a different reflection or echo. After the corresponding delay is added to Rin, the resultant signal is coupled to a full rate adaptive filter (FRAD) section, e.g., FRAD section 1-FRAD section 3 327, 329, 331. The FRAD sections each operate on Rin as well as an error signal to provide an echo or reflection replica that together with Sin 107 is coupled to a summer 333 where the corresponding replica is subtracted from Sin 107. The output from the summer 333 or resultant signal (designated “error”) is ideally only the signal that is desired to be sent from the near end, e.g. telephone 101. In practice some reflection energy or artifacts of echo cancellation will remain in the error signal. The error signal is coupled to and contributes to further operation of the various FRAD sections as shown as well as coupled to the NLP 309. As noted above the NLP removes remaining reflection or echo energy or covers them up with comfort noise. While three delay functions and FRAD sections are shown, in practice, this number can range from 1 or more, depending on the number of reflections that are detected.

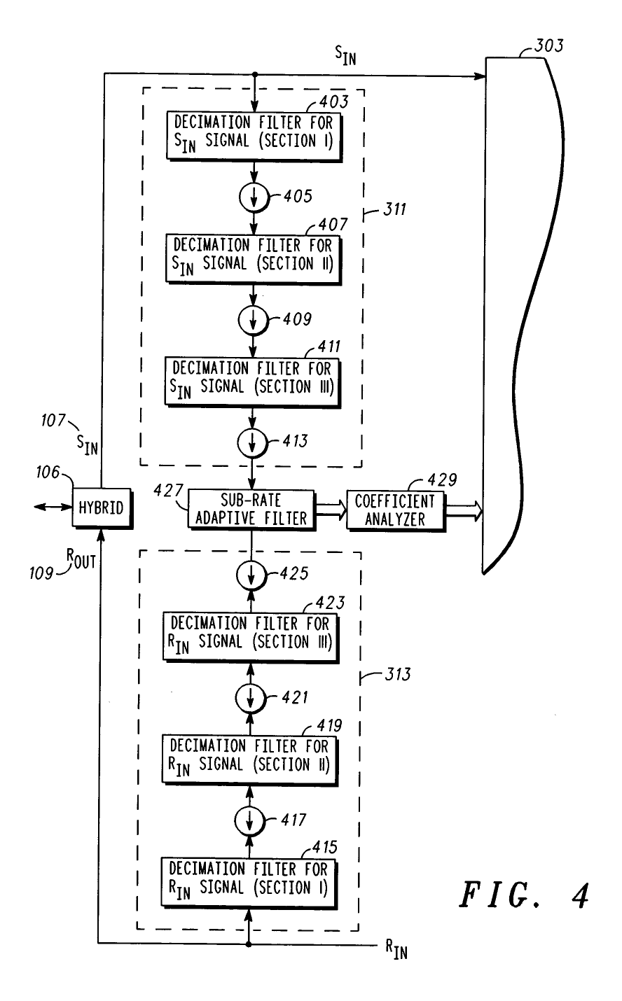

Referring to FIG. 4, a representative and more detailed high level diagram of a system for detecting reflections in accordance with one or more embodiments will be discussed and described. FIG. 4 shows an embodiment where the multi-rate filtering system 311 and the multi-rate filtering system 313 each further comprise a plurality of filters and decimators configured to provide a corresponding one of the first filtered signal and the second filtered signal to a sub rate adaptive filter 427 which provides coefficients to a coefficient analyzer 429 and forwards delays to 303. Note that the sub rate adaptive filter 427 and coefficient analyzer 429 can be similar or identical to the sub rate adaptive filter 315 and coefficient analyzer. More specifically, in the embodiment of FIG. 4 the plurality of filters and decimators for each of the multi-rate filtering systems 311, 313 further comprises a plurality of series coupled decimation filters and decimators.

For the multi-rate filtering system 311, the plurality of series coupled decimation filters and decimators further comprises a first decimation filter 403 and a first decimator 405 for decimating a signal at the output of the first decimation filter to provide a first filtered and decimated signal, a second decimation filter 407 for filtering the first filtered and decimated signal and a second decimator 409 for decimating a signal at the output of the second decimation filter to provide a second filtered and decimated signal, and a third decimation filter 411 for filtering the second filtered and decimated signal and a third decimator 413 for decimating a signal at the output of the third decimation filter to provide the corresponding first filtered signal from the multi-rate filtering system 311.

Similarly, for the multi-rate filtering system 313, the plurality of series coupled decimation filters and decimators further comprises a first decimation filter 415 and a first decimator 417 for decimating a signal at the output of the first decimation filter to provide a first filtered and decimated signal, a second decimation filter 419 for filtering the first filtered and decimated signal and a second decimator 321 for decimating a signal at the output of the second decimation filter to provide a second filtered and decimated signal, and a third decimation filter 423 for filtering the second filtered and decimated signal and a third decimator 425 for decimating a signal at the output of the third decimation filter to provide the corresponding second filtered signal from the multi-rate filtering system 313. As noted above, the multi-rate filtering systems (311, 313) may vary from one another; however in practice they are typically similar if not identical or nearly identical. Furthermore, although three filters and three decimators are shown for each multi-rate filtering system, the concepts and principles discussed and disclosed are equally applicable, for example, to two or four or more filters and decimators.

Known approaches for implementing filters in an echo or reflection detector normally use one decimation filter followed by a single decimator where the filter has a response that substantially reduces any aliasing energy. For example, one approach uses a filter followed by a decimator that has a decimation rate of 8, i.e., the decimator essentially selects one out of every 8 samples. In this instance in a telephone channel, the effective sampling rate is reduced from 8 KS/s to 1 KS/s and thus signals with frequencies in a bandwidth of 500 Hz can be reproduced provided aliasing energy repeated at multiples of 1 KHz is sufficiently reduced, e.g., 30-40 dB reduction.

By using the distributed filtering and decimating approach depicted in FIG. 4 and generally described above it can be shown (via applying noble identities for swapping decimation and filtering operations) that the processing steps or processing capacity required can be reduced from 3 times the number of steps for any one of the 3 filters to 1.75 times the number of steps for any one filter, i.e., a 42% reduction. For example if each of the three decimators is using a factor of 2, i.e., selects every other one of the input samples, the effective decimation rate, Deff, equals 8. The first filter 403, 415 will operate at an 8 KS/s rate, the second filter 407, 419 will operate at a 4 KS/s rate, the last or third filter 411, 423 will operate at a 2 KS/s rate, and the sub rate adaptive filter 427 will operate at a 1 KS/s second rate. It is also noted that the filtering and decimation need not be equally distributed as in this example. For example, a Deff rate equal to 8 could be obtained by using a first decimator with a rate of 4 followed by another with a rate of 2 and these could be combined with or without a further filter prior to the sub rate adaptive filter. A Deff of 16 could be obtained using decimation rates of 4 and 4 or 4, 2, and 2 and so forth.

Other characteristics of the filters, e.g., bandwidth and center frequency, may also be determined or at least constrained by the various decimation rates. For example, a decimation filter normally limits the bandwidth of an output signal to a maximum of one half of the output sample rate of a decimator that follows the filter in accordance with Nyquist criteria. Thus the maximum bandwidth of the first filter would be limited to 2 KHz, the second filter maximum bandwidth to 1 KHz and the final or third filter to 500 Hz when the decimators factors are each 2. Of course these bandwidths can and often do have bandwidths that are narrower than the maximum. The center frequency of the filters is selected such that they will in all likelihood pass energy that is due to reflections or echoes as well as traffic or voice signal energy and test signal energy, e.g., in accordance with one or more echo path models, composite source signal spectra and channel bandwidths as will be further discussed below

Furthermore, if the processing steps for implementing a filter can be reduced, e.g., using efficient filters or by reducing the selectivity of the filter albeit with a corresponding increase in aliasing, processing costs or capacity can be further reduced thus resulting in additional savings. For example, where at least one of the first multi-rate filtering system 311 and the second multi-rate filtering system 313 further comprises a plurality of series coupled filters with each filter having a Goertzel or modified Goertzel structure, additional processing or computational costs or capacity savings can be realized. In this instance the overall response of 3 filters H(z) can be selected by:
Selecting a reference filter H_{ref}(z)=G₀/[A₁(z)A₂(z)A₃(z)]
where Aᵢ(z)=1−2rᵢ cos(θᵢ)z⁻¹+rᵢ²z⁻², i=1, 2, 3.
Set H(z)=H(z)=G/[A₁′(z)A₂′(z)A₃′(z)],
where Aᵢ′(z)=1−2vᵢ cos(αᵢ)z⁻¹+vᵢ²z⁻², i=1, 2, 3,
with variables defined as: vᵢ=rᵢⁿ^{ᵢ}, αᵢ=nᵢθᵢ, nᵢ=2ⁱ⁻¹, i=1, 2, 3,

where rᵢ and θᵢ are selected for an appropriate response and G is given as the magnitude: G=∥A₁′(e^{jω})A₂′(e^{jω})A₃′(e^{jω})∥_{∞}⁻¹, which is the inverse of the L_{∞} norm of the denominator of H(z) on the unit circle z=e^{jω}, j=\sqrt{−1}, such that its largest magnitude (in the frequency domain) is one.

If aliasing minimization, given this form of filter, is desired one can adjust the filter parameters rᵢ, i=1, 2, 3, such that the L₂ norm |∥H_{ref} (e^{jω})−H(e^{jω})∥₂ is minimized.

Given the above equations, in order to provide a distributed filter equivalent to H_{ref}, replace H_{ref} followed by decimation by D_{eff}=8 with, collectively 1/A₁′ (z), decimation by D=2, 1/A₂′ (z), decimation by D=2, 1/A₃′ (z), decimation by D=2, followed by a gain G. Using the above approach provides filtered signals corresponding to Rin and Sin to the subrate adaptive filter, which can perform adaptation for the purpose of obtaining the adaptive filter coefficients. This, in turn, serves the purpose of estimating reflection location or positions or parameters in a communication system.

Referring to FIG. 5, a diagram of a response, i.e., bandpass response, for each of three Goertzel filters suitable for use in one or more embodiments of the system for detecting reflections of FIG. 4 in accordance with one or more embodiments will be discussed and described. FIG. 5 shows plots of the magnitude response with frequency on the horizontal axis 501 and relative magnitude in dB on the vertical axis 503. As depicted, a first filter has a response as shown at 505, a second filter has a response as shown at 507 and a third filter has a response as shown at 509. The overall response of a multi-rate filter using these 3 filters is the sum of these 3 response curves.

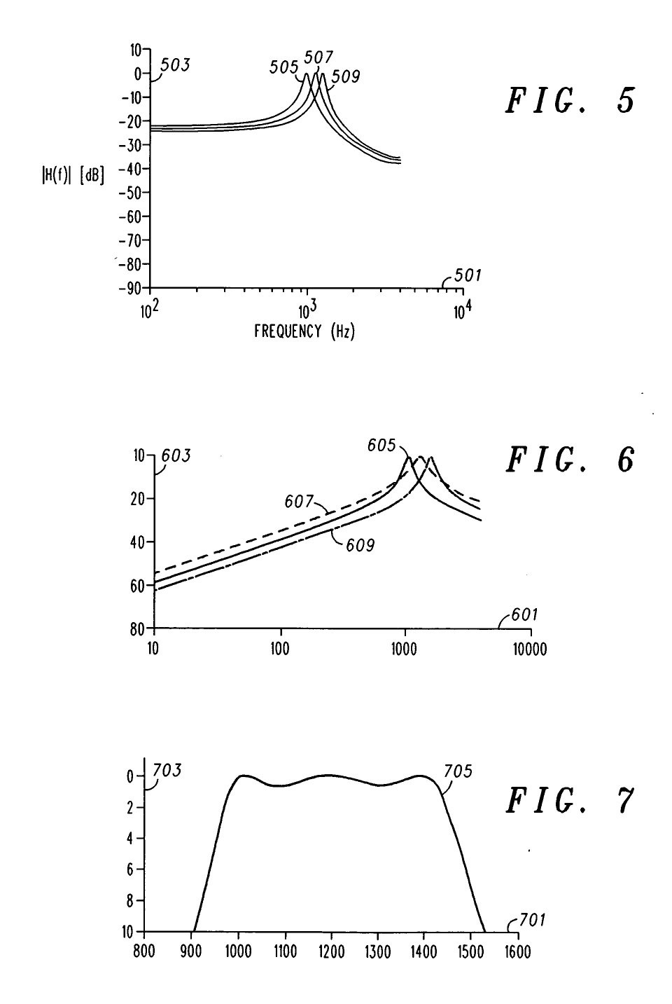

Referring to FIG. 6, a diagram of a response for each of three resonant filters suitable for use in one or more embodiments of the FIG. 4 system for detecting reflections in accordance with one or more embodiments will be discussed and described. Using resonant filters is an additional approach for implementing one or more of the multi-rate filters that comprise a plurality of series coupled filters with each filter having a resonant response. The three filters in this instance can be implemented as resistor inductor capacitor filters or the equivalent of such filters where the desired filter response H_{ref}(z) is given by the product of H₁(z) H₂(z) H₃(z) of the respective filters and any of the filters has a transmittance function described by matrices Aᵢ=[1 aᵢ₂ aᵢ₃] and Bᵢ=[bᵢ₁0bᵢ₃] with i=1, 2, 3 (when there are three filters) where the poles and zeros of any Hᵢ are selected to have a large Q factor and thus steep roll off.

Note that another approach to implementing resonant filters is using series coupled infinite impulse response filters with each filter having a second order response. Yet another approach is using the Goertzel filter structure discussed above together with an additional finite impulse response filter such that H_{new}(z)=H_{FIR}(z) H(z) with H_{FIR}(Z) having a form, such as (1−z⁻²)³

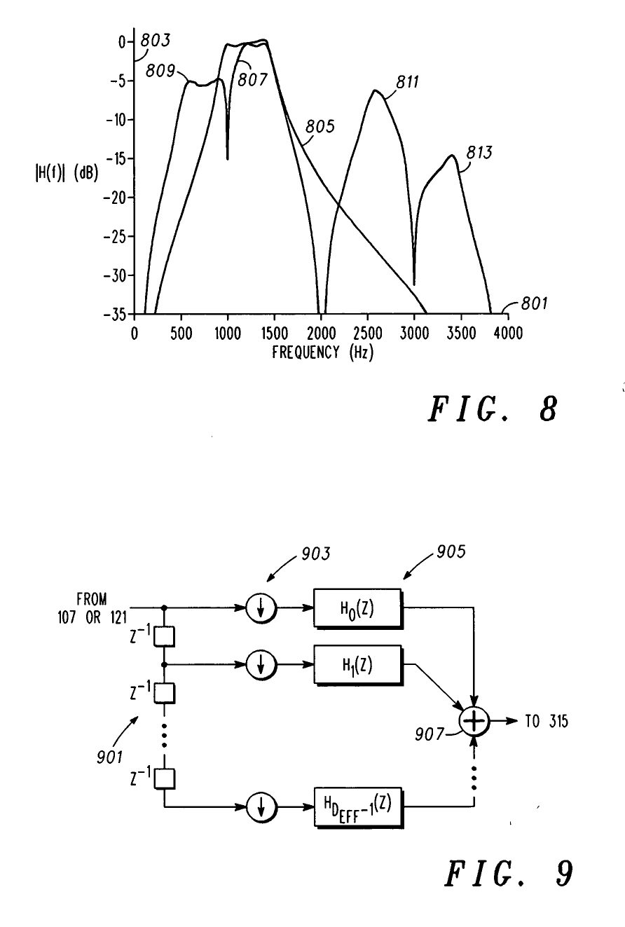

FIG. 6 has a horizontal axis 601 that shows frequency and a vertical axis that shows relative amplitude in dB. A first filter response curve 605, a second filter response curve 607 and a third filter response curve are depicted with each filter having limited roll off at multiples of a center frequency as well as slightly varying center frequency. FIG. 7 shows a composite view of these responses with the horizontal axis 701 showing frequency and the vertical axis 703 showing amplitude in dB. The composite response 705 is centered near 1200 Hz with a pass band extending from slightly below 1000 Hz to above 1400 Hz. FIG. 8 illustrates a diagram of another composite response for another embodiment of three resonant filters suitable for use in one or more embodiments of the FIG. 4 system for detecting reflections. Specifically FIG. 8 shows frequency on a horizontal axis 801 and relative amplitude on a vertical axis 803 together with an exemplary reference response 805 that might be expected in prior art filters and a composite response 807 when one embodiment of second order infinite impulse response (IIR) filters are cascaded. IIR filters are known and second order IIR filters are such filters where a current output is a combination of a current input, two immediately previous inputs, and two immediately previous outputs each weighted in accordance with filter coefficients that are selected to provide particular filter characteristics. By observation the reference response provides significantly more attenuation than the composite response for any aliasing energy in the 500-1000 Hz band 809 as well as for any aliasing energy around 2600 Hz 811 and 3400 Hz 813. Nevertheless, it has been found that a multi-rate filter corresponding to the composite response 807 can be used to reliably identify or detect reflections and corresponding delays with significantly lower processing costs or capacity than a traditional filter corresponding to the reference response 805.

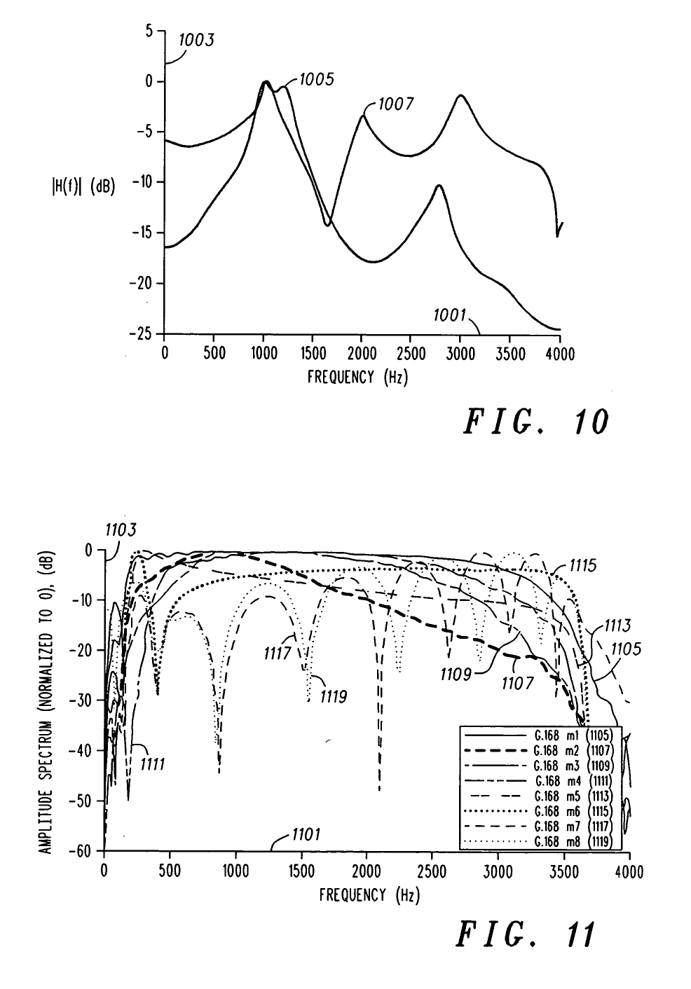

Referring to FIG. 9, another embodiment of a multi-rate filtering system suitable for use in the system for detecting reflections of FIG. 3 in accordance with one or more embodiments will be discussed and described. FIG. 9 shows a filter structure that can be utilized for either of the multi rate filters or filtering systems 311, 313 where the multi-rate filtering system comprises a plurality of filters and decimators that are configured to provide a corresponding filtered signal. This multi-rate filter structure or filtering system comprises a plurality of parallel coupled filters, e.g., finite impulse response filters or infinite impulse response filters with each filter having, e.g., a first order response. The exemplary filter structure that is depicted is sometimes referred to as a polyphase filter or decomposition function or filter. The input to the filter of FIG. 9 comes from Sin 107 (as filtered by high pass filter 305) or alternatively Rin 121 (after filtering by high pass filter 319) and is coupled to a series coupled string of delay stages 901. The input at each of the delay stages 901 is coupled to a corresponding one of a plurality of parallel coupled members with each member comprising a series coupled decimator and filter. The plurality of decimators 903 and plurality of filters 905 in one or more embodiments comprises a polyphase decomposition function that is further configured such that an output from each of the plurality of filters are combined via a summer 907 to provide the corresponding filtered signal which is coupled to a sub rate adaptive filter, e.g., sub rate adaptive filter 315.

In the polyphase structure the number of delay stages typically will be one less than the effective decimation rate Deff while the number of parallel members, thus decimators and filters will be equal to Deff. Thus for Deff=8, there will be 7 delay stages, 8 decimators and 8 filters (H₀(z)−H_{Deff-1}(z)). Each of the decimators will decimate by Deff and thus, where Deff=8, each decimator will select 1 out of each 8 samples. Given that all decimators select a sample at the same time, each sample of the input signal will be utilized while each parallel member will filter 1 out of every 8 samples. Typical values for Deff here as well in the exemplary structures noted above are 4, 8, or 16.

In practice, the polyphase decomposition function can be implemented as follow. Initially select a reference filter H_{ref}(z)=B(z)/A(z) where this filter has an appropriate response for a multi-rate filter, e.g., multi-rate filter 311, 313. Then estimate an impulse response h(n) of Href(z) and truncate the number of coefficients of h(n) to N×D taps, where D=Deff. Next, define the polyphase coefficients of D FIR filters hₖ(n)=h(D·n+k), k=0, 1, . . . , D−1, n=0, 1, . . . , N−1. If a FIR approximation is desired, calculate αₖ and βₖ per

$$α - k = {\sum }_{n = 0}^{N - 1} {h}_{k}^{2} ( n ) , \\ {β}_{k} = {\sum }_{n = 1}^{N - 1} {h}_{k} ( n ) {h}_{k} ( n - 1 )$$

and define the coefficients of D 1st-order IIR filters Hₖᵢ(z)=bₖ/(1−aₖz⁻¹), where
bₖ=(αₖ²−βₖ²)/(αₖhₖ(0)), aₖ=βₖ/αₖ.
These correspond to 1st order IIR approximations of the polyphase filters by determining their 1st-order FIR equalizers.

The final polyphase filter structure based on these approximations is then given by:

$$H ( z ) = G {\sum }_{k = 0}^{D - 1} {z}^{- k} {H}_{k} ( {z}^{D} ) , \\ G = {‖ {\sum }_{k = 0}^{D - 1} {ⅇ}^{- j k ω} {H}_{k} ( {ⅇ}^{j D ω} ) ‖}_{∞}^{- 1}$$

H_{ref}(z) followed by decimation by D is replaced with a bank of filters Hₖ(z) running at 1/D of the original sampling rate where the output is provided to a sub rate adaptive filter and this filter performs adaptation for the purpose of obtaining the sub rate adaptive filter coefficients, which are used for determining the location of reflections or determining echo or reflection parameters in a communication channel.

Referring to FIG. 10, a diagram of a composite response for the multi-rate filtering system of FIG. 9 in accordance with one or more embodiments will be briefly discussed and described. FIG. 10 shows frequency on a horizontal axis 1001 and relative amplitude on a vertical axis 1003. The response of a reference filter is shown by the curve 1005 and a response for a polyphase structure is shown by curve 1007. By observation, while both filters pass energy in a band around 1000 Hz, the polyphase structure or filter has significantly less attenuation, e.g., at 2000 Hz and 3000 Hz. This will result in more aliasing energy being present in a filtered signal that is presented to the sub rate adaptive filter. This increase in aliasing notwithstanding, it has been experimentally determined that the polyphase filter still serves the purpose of reliably determining or detecting echoes or reflections for purposes of performing echo cancellation at a substantial reduction, e.g., 80% reduction, in processing costs or capacity.

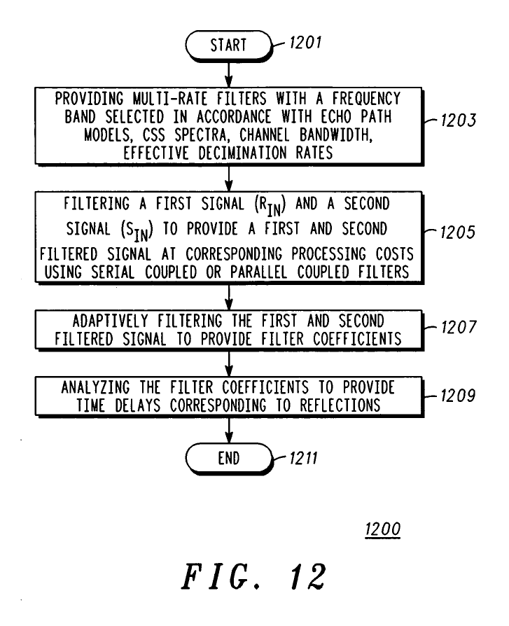

Referring to FIG. 11, various energy distribution diagrams in accordance with various standardized echo models will be discussed and described. The diagram of FIG. 11 is exemplary of various information that can be utilized when selecting the center frequencies as well as bandwidth of the multi-rate filter or filtering systems that have been discussed above. FIG. 11 (with frequency on the horizontal axis 1101 and relative magnitude in dB on the vertical axis 1103) shows the energy distribution for reflections or echoes that can be expected when various embodiments of hybrids are excited with a test signal, according to the G.168 standard available from the International Telecommunication Union (ITU). These echo path models (m1 curve 1105 through m8 curve 1119) are generated from a network hybrid simulator and used to test or evaluate echo cancellers.

Other accepted standardized test signals include one or more composite source signals with known characteristics or spectra (not specifically depicted but available from the ITU-T Recommendation G.168). Of course the echo canceller has to operate in a real world environment with a particular channel characteristic, such as a telephony channel with a bandwidth of 0-4000 Hz with voice traffic largely limited to 300-3400 Hz (Note: the telephone range is often quoted as 300-3400 Hz or 300-3300 Hz). Another factor in choosing a center frequency has to do with the available bandwidth of the signal that will be presented to the sub rate adaptive filter by the multi-rate filters 311, 313 and various embodiments thereof. The bandwidth of the signal presented to the sub rate adaptive filter will be around or less than 4000 Hz divided by Deff. With Deff=8 this bandwidth can be approximately 500 Hz, with Deff=4 the bandwidth can be up to 1000 Hz, and with Deff=16 the bandwidth can be up to 250 Hz.

In view of these issues, the practitioner thus selects a bandwidth for each of the multi-rate filtering systems and in accordance with one or more of an echo path model, a composite source signal spectra, and a channel bandwidth, e.g., a telephony channel bandwidth, given that the multi-rate filtering system should have a filter pass band corresponding to 4 KHz divided by an effective decimation rate associated with the multi-rate filtering system. Thus by way of example with Deff=8, a practitioner can choose a 500 Hz band that extends from 900+ to 1400+ Hz and be reasonably certain that energy from any of the echo path models (m1-m8) will be available. This band is also within the generally known band for voice traffic on a telephone channel and will include significant components of the composite source signals, i.e., two significant components, according to ITU G.168. Note that it may be appropriate to choose a bandwidth that is narrower than the maximum supported by a particular sample rate. For example, where Deff=4 and a bandwidth of 1000 Hz could be used, it may be appropriate to select a bandwidth around 700-800 Hz that starts near 800 Hz and ends near 1500 Hz given the G.168 echo models.

FIG. 12 shows a flow chart illustrating representative embodiments of one or more methods of detecting reflections in a communication channel. Note that much of this discussion will be a review of certain concepts and principles discussed and described above and thus the reader is referred to those discussions for appropriate details. It will be evident to those of ordinary skill in view of earlier discussions that the methods described below can be implemented with one or more embodiments in accordance with the above described apparatus or with other appropriately configured apparatus.

FIG. 12 depicts various method(s) 1200 of or associated with detecting reflections in a communication channel. The method 1200 starts at 1201 and begins at 1203 with providing multi-rate filters or filter systems having characteristics, e.g., center frequency, frequency bands, bandwidth, etc. that are selected in accordance with at least one of an echo path model, a composite source signal spectra, and a telephony channel bandwidth. This selection also normally accounts for channel bandwidth and effective decimation rates used by the filters. For example, for a telephone channel, selecting the filter band further comprises selecting a frequency band corresponding to 4 KHz divided by an effective decimation rate associated with at least one of the first multi-rate filtering systems.

Given the multi-rate filters 1205 shows filtering a first signal using a first multi-rate filtering system to provide a first filtered signal, e.g., at a first processing cost and filtering a second signal using a second multi-rate filtering system to provide a second filtered signal, e.g., at a second processing cost where the filtering uses one of serial coupled or parallel coupled filters. In particular it is expected that the first processing cost and the second processing cost will be reduced by increasing aliasing, e.g., possibly decreasing selectivity, due to multi-rate filtering. Various approaches are contemplated for the filtering. In one embodiment, at least one of the filtering the first signal and filtering the second signal further comprises filtering and decimating one of the first signal and the second signal through a plurality of filters and decimators to provide a corresponding one of the first filtered signal and the second filtered signal. This can comprise filtering and decimating the first signal and the second signal through a plurality of series coupled decimation filters and decimators or alternatively decimating and filtering the first signal and the second signal through a plurality of parallel coupled decimation and filtering functions.

When series coupled filters and decimators are used, one embodiment further comprises filtering each of the first signal and the second signal using a first decimation filter and decimating a signal at the output of the first decimation filter to provide a first filtered and decimated signal, filtering the first filtered and decimated signal using a second decimation filter and decimating a signal at the output of the second decimation filter to provide a second filtered and decimated signal, and filtering the second filtered and decimated signal using a third decimation filter and decimating a signal at the output of the third decimation filter to provide the corresponding one of the first filtered signal and the second filtered signal. Various filter structures are contemplated including Goertzel filters, 2^{nd} order IIR filters, or other resonant filters.

When parallel coupled arrangement is used, the decimating and filtering the first signal and the second signal through a plurality of parallel coupled decimation and filtering functions can comprises a polyphase decomposition of the one of the first signal and the second signal using a plurality of parallel coupled processing members, where each member includes a decimator series coupled to a filter, with the outputs of all of the members combined to provide the corresponding one of the first filtered signal and the second filtered signal.

After the filtering processes, 1207 shows adaptively filtering the first filtered signal and the second filtered signal to provide filter coefficients and then analyzing 1209 the filter coefficients to provide a time delay corresponding to each of one or more reflections. The method(s) 1200 end 1211 but may be repeated as needed and in fact would normally repeat from 1205.

It will be appreciated that the above described functions and structures may be implemented in one or more integrated circuits. For example, many or all of the functions can be implemented in the signal processing circuitry that is suggested by FIG. 1

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of detecting reflections in a communication channel comprising:
filtering a first signal using a first multi-rate filtering system having a first bandpass characteristic to provide a first filtered signal;
filtering a second signal using a second multi-rate filtering system having a second bandpass characteristic to provide a second filtered signal;
adaptively filtering the first filtered signal and the second filtered signal to provide filter coefficients; and
analyzing the filter coefficients to provide a time delay corresponding to each of one or more reflections.

2. The method of claim 1 where the filtering the first signal incurs a first processing cost and filtering the second signal incurs a second processing cost and, where at least one of the first processing cost and the second processing cost is reduced by increasing aliasing due to multi-rate filtering.

3. The method of claim 1 further comprising selecting a filter band to use for at least one of the filtering the first signal and the filtering the second signal, where the selecting the filter band is in accordance with at least one of an echo path model, a composite source signal spectra, and a channel bandwidth.

4. The method of claim 1 where the selecting the filter band further comprises selecting a frequency band corresponding to 4 KHz divided by an effective decimation rate associated with at least one of the first multi-rate filtering system and the second multi-rate filtering system.

5. The method of claim 1 where at least one of the filtering the first signal and filtering the second signal further comprises filtering and decimating one of the first signal and the second signal through a plurality of filters and decimators to provide a corresponding one of the first filtered signal and the second filtered signal.

6. The method of claim 5 where the filtering and decimating one of the first signal and the second signal through a plurality of filters and decimators further comprises filtering and decimating one of the first signal and the second signal through a plurality of series coupled decimation filters and decimators.

7. The method of claim 6 where the filtering and decimating one of the first signal and the second signal through a plurality of decimation filters and decimators that are series coupled further comprises filtering the one of the first signal and the second signal using a first decimation filter and decimating a signal at the output of the first decimation filter to provide a first filtered and decimated signal, filtering the first filtered and decimated signal using a second decimation filter and decimating a signal at the output of the second decimation filter to provide a second filtered and decimated signal, and filtering the second filtered and decimated signal using a third decimation filter and decimating a signal at the output of the third decimation filter to provide the corresponding one of the first filtered signal and the second filtered signal.

8. The method of claim 5 where the filtering and decimating one of the first signal and the second signal through a plurality of filters and decimators further comprises decimating and filtering the one of the first signal and the second signal through a plurality of parallel coupled decimation and filtering functions.

9. The method of claim 8 where the decimating and filtering the one of the first signal and the second signal through a plurality of parallel coupled decimation and filtering functions further comprises a polyphase decomposition of the one of the first signal and the second signal using a plurality of parallel coupled processing members, each member including a decimator series coupled to a filter, with the outputs of all of the members combined to provide the corresponding one of the first filtered signal and the second filtered signal.

10. A system for detecting reflections in a communication channel, the system comprising:
a first multi-rate filtering system having a first bandpass characteristic and configured to filter and decimate a first signal at a first sample rate and provide a corresponding first filtered signal at a first reduced sample rate;
a second multi-rate filtering system having a second bandpass characteristic and configured to filter and decimate a second signal at a second sample rate and provide a corresponding second filtered signal at a second reduced sample rate;
a sub rate adaptive filter configured to process the first filtered signal and the second filtered signal to provide filter coefficients; and
a coefficient analyzer configured to analyze the filter coefficients and provide a time delay corresponding to each of one or more reflections.

11. The system of claim 10 where the first multi-rate filtering system has a first processing cost and the second multi-rate filtering system has a second processing cost and where at least one of the first processing cost and the second processing cost is reduced by increasing aliasing due to multi-rate filtering.

12. The system of claim 10 where at least one of the first multi-rate filtering system and the second multi-rate filtering system further has a filter pass band that is selected in accordance with at least one of an echo path model, a composite source signal spectra, and a telephony channel bandwidth.

13. The system of claim 10 where the at least one of the first multi-rate filtering system and the second multi-rate filtering system has a filter pass band corresponding to 4 KHz divided by an effective decimation rate associated with at least one of the first multi-rate filtering system and the second multi-rate filtering system.

14. The system of claim 10 where at least one of the first multi-rate filtering system and the second multi-rate filtering system further comprises a plurality of filters and decimators configured to provide a corresponding one of the first filtered signal and the second filtered signal.

15. The system of claim 14 where the plurality of filters and decimators further comprises a plurality of series coupled decimation filters and decimators.

16. The system of claim 15 where the plurality of series coupled decimation filters and decimators further comprises a first decimation filter and a first decimator for decimating a signal at the output of the first decimation filter to provide a first filtered and decimated signal, a second decimation filter for filtering the first filtered and decimated signal and a second decimator for decimating a signal at the output of the second decimation filter to provide a second filtered and decimated signal, and a third decimation filter for filtering the second filtered and decimated signal and a third decimator for decimating a signal at the output of the third decimation filter to provide the corresponding one of the first filtered signal and the second filtered signal.

17. The system of claim 14 where the plurality of filters and decimators further comprises a plurality of parallel coupled members with each member comprising a series coupled decimator and filter.

18. The system of claim 17 where the plurality of filters and decimators further comprise a polyphase decomposition function where outputs from each filter are combined to provide the corresponding one of the first filtered signal and the second filtered signal.

19. The system of claim 10 where at least one of the first multi-rate filtering system and the second multi-rate filtering system further comprise a plurality of series coupled filters with each filter having a Goertzel structure.

20. The system of claim 10 where at least one of the first multi-rate filtering system and the second multi-rate filtering system further comprise a plurality of series coupled infinite impulse response filters with each filter having a second order response.

21. The system of claim 10 where at least one of the first multi-rate filtering system and the second multi-rate filtering system further comprise a plurality of series coupled filters with each filter having a resonant response.

22. The system of claim 10 where at least one of the first multi-rate filtering system and the second multi-rate filtering system further comprise a plurality of parallel coupled infinite impulse response filters with each filter having a first order response.
